(19) United States
(12) Patent Application Publication
(10) Pub. No.: US 2026/0134384 A1
(43) Pub. Date: May 14, 2026

(54) SYSTEMS AND METHODS FOR RECOVERING UNREPORTED RETURNS IN E-COMMERCE PLATFORM

(71) Applicant: Coupang Corp., Seoul (KR)

(72) Inventors: Sai Chaitanya Mallampati, Seattle, WA (US); Srijit Sengupta, Seoul (KR); Tianyang Che, Seattle, WA (US); Pankaj Ghanshani, Seoul (KR); Sujeong Cho, Seoul (KR); Manjeet Bawa-Cavia, Seattle, WA (US)

(21) Appl. No.: 18/942,068

(22) Filed: Nov. 8, 2024

(51) Int. Cl. G06Q 10/0837; G06Q 10/087

(52) U.S. Cl. CPC G06Q 10/0837; G06Q 10/087

(57) ABSTRACT

A method for processing returns in e-commerce transactions includes: receiving information encoded in an identifier associated with an item being returned; obtaining condition data indicative of condition of the item; obtaining inventory information including identification of candidate return transactions not associated with corresponding return invoices, where the candidate return transactions satisfy a condition in which an amount of elapsed time since an initiation of a respective return process meets a first threshold condition; determining, based on the condition data and a set of rules, a particular transaction associated with the item; determining, based on the condition data, an allocation of relative responsibility among a seller associated with the particular transaction, a customer, and an ecommerce provider regarding compensation associated with the return process; generating a data representing the relative responsibility; and updating inventory information of the seller associated with the particular transaction to reflect return status of the item.

### TECHNICAL FIELD

This description generally relates to systems and methods for recovering unreported return data and enhancing data integrity in an e-commerce platform.

### BACKGROUND

In general, in the e-commerce industry, a return invoice serves several different functions. It includes details like the order number, item descriptions, prices, and seller information. This information is essential for directing return packages to the correct seller, processing returns accurately, managing inventory, providing customer service, and maintaining proper accounting. For instance, the return invoice helps logistics providers route packages back to sellers and allows sellers to verify returned items against the original order. An intact and legible return invoice may be needed for efficient returns.

### SUMMARY

Implementations according to this disclosure includes a method for processing returns in e-commerce transactions. The method includes receiving, at one or more processing devices, information encoded in an identifier associated with a first item being returned, the identifier being provided on a packaging of the first item; obtaining, by the one or more processing devices, condition data indicative of condition of the first item; obtaining, by the one or more processing devices, inventory information including identification of a candidate return transactions not associated with corresponding return invoices, where the candidate return transactions (i) are associated with one or more sellers of items substantially similar to, or of the same type as, the first item and (ii) satisfy a condition in which an amount of elapsed time from an initiation of a respective return process meets a first threshold condition; determining, by the one or more processing devices and based on (i) the condition data and (ii) a first set of rules, a particular transaction, among the candidate return transactions, associated with the first item; determining, by the one or more processing devices and based on the condition data, an allocation of relative responsibility among a seller associated with the particular transaction, a customer, and an ecommerce provider regarding compensation associated with the return process; generating, by the one or more processing devices, a data representing the relative responsibility; and updating, by the one or more processing devices, inventory information of the seller associated with the particular transaction to reflect return status of the first item.

Implementations according to this disclosure includes a system for processing unreported returns in e-commerce transactions. The system includes at least one processor and a memory subsystem communicatively coupled to the at least one processor. The memory subsystem stores instructions which, when executed by the at least one processor, cause the at least one processor to perform operations including: receiving information encoded in an identifier associated with a first item being returned, the identifier being provided on a packaging of the first item; obtaining condition data indicative of condition of the first item; obtaining inventory information including identification of candidate return transactions not associated with corresponding return invoices, where the candidate return transactions (i) are associated with one or more sellers of items substantially similar to, or of the same type as, the first item and (ii) satisfy a condition in which an amount of elapsed time from an initiation of a respective return process meets a first threshold condition; determining, based on (i) the condition data and (ii) a first set of rules, a particular transaction, among the candidate return transactions, associated with the first item; determining, based on the condition data, an allocation of relative responsibility among a seller associated with the particular transaction, a customer, and an ecommerce provider regarding compensation associated with the return process; generating a data representing the relative responsibility; and updating inventory information of the seller associated with the particular transaction to reflect return status of the first item.

Other embodiments of this aspect include corresponding computer systems, apparatus, and computer programs recorded on one or more computer storage devices, each configured to perform the actions or operations described herein. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by a data processing apparatus, cause the apparatus to perform the actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example e-commerce return tracking system.

FIG. 2 is an example implementation of returns processing software or algorithm that is utilized by an electronic device.

FIG. 3 is a flow chart diagram of an example process for determining a responsibility data for unreported returns in e-commerce transaction.

FIG. 4 is a diagram of an example computer system.

Like reference numbers and designations in the various drawings indicate like elements.

### DETAILED DESCRIPTION

In the e-commerce industry, it is common for customers to initiate the return process for products they have purchased. When the invoice (a formal record of the sale transaction) attached to the return package is damaged (or the return process lacks a clear and intact return invoice), it becomes challenging to identify the seller. This technical difficulty in matching the seller to the returned product often results in the package being categorized as an “unreported” return.

In such cases, unreported return packages are not correctly matched to the sellers (or seller's inventory) who are supposed to receive them. This can lead to several issues. These issues can include misdirected packages, delayed refunds, incorrect inventory records, increased operational costs, and potential disputes between sellers and the e-commerce platform provider.

In particular, this situation often leads to losses for the e-commerce platform owners. For example, when multiple returned products with damaged invoices or missing identifier information cannot be identified among various sellers, the sellers are often compensated by the e-commerce platform provider regardless of whether the responsibility lies with the seller or the consumer, depending on the condition of the product.

In some cases, even in situations where [1] the seller is being at least partially responsible for the product being originally damaged when it was shipped out to the consumer, [2] the consumer is at least partially responsible for the product being returned in used condition, or [3] the consumer, seller, or ecommerce platform provider is at least partially responsible for the product being returned in scrapped condition, e-commerce platform provider take full responsibility and the seller is fully compensated due to “unreported” nature of such incidences.

Implementations according to this disclosure address issues such as those described above by at least [1] tracking transactions corresponding to unreported returns, identifying a seller or seller's inventory corresponding to an unreported return of an item based on an identification method that is different from using a return invoice, [3] obtaining condition data indicative of condition of the item corresponding to the unreported return, [4] determining, based on the condition data and a set of rules, a transaction associated with the unreported return among multiple transactions within the seller's inventory (or return data portion of the seller's inventory), [5] determining and assigning relative responsibility to appropriate party among the seller, the customer, and the ecommerce platform provider, and/or [6] generating data that represents the relative responsibility for data storage and/or output for user display.

In some implementations, during a certain time period, one or more processing devices can track and determine one or more transactions corresponding to unreported returns (e.g., returns that lack return invoice(s) or exhibit damaged invoice(s)). In an example, certain time period can be determined based on (i) last determination date for the receipt of return invoice of item(s) since an initiation of the return processes and/or (ii) last determination date for the compensation regarding returns.

In some implementations, seller(s) corresponding to the unreported returns can be identified or determined based on a stock keeping unit identifier (SKUID). For instance, the seller identifier information can be determined based on scanning of a barcode (e.g., SKU barcode) associated with the SKUID that is provided at an original packaging of an item. For instance, within a data store of an e-commerce platform, the SKUID can be associated with one or more sellers or the inventory information of the one or more sellers.

In some implementations, the condition of the item can be determined based on an entity inspection, and/or machine learning (ML) model. For instance, the ML model (which can be a deep-learning model) can be trained to determine the condition of the item, for example, based on one or more pictures of the item.

In some implementations, the transaction associated with the unreported return among multiple transactions within the seller's inventory (or return data associated with the seller's inventory) can be determined based on the condition data and a first set of rules. For example, the first set of rules can include (i) searching, among multiple transactions, for one or more transactions that matches the condition of the item indicated by the condition data, and (ii) identifying, among the one or more transactions that match the condition of the item indicated by the condition data, a transaction with greatest amount of elapsed time since an initiation of a respective return process.

In some implementations, the relative responsibility regarding compensation of the return can be determined based on a second set of rules, and the relative responsibility can be assigned to appropriate party among the seller, the customer, and the ecommerce platform provider. The second set of rules can include set of instructions for determining an allocation of responsibility. For example, when the item is in scrapped condition, the e-commerce provider can take the full responsibility and compensate the seller to benefit the seller. For example, when the item is in new condition, the item can be simply re-stocked for sale and thus, responsibility determination may not be necessary or voided. For example, when the item is in used condition, determination of allocation can depend on internal policy or further set of criteria.

Once the relative responsibility is determined and/or assigned, the data corresponding to such relative responsibility can be generated for data storage and/or output for user display. Further, in some implementations, inventory information of the seller associated with the particular transaction can be updated to reflect return status of the item.

By addressing the above-mentioned issues using the implementations described above and throughout this disclosure, unreported returns can be efficiently tracked and the relative responsibility can be accurately determined and assigned among the seller, the customer, and the ecommerce provider.

In some implementations, the technology described herein allows for accurately identifying—even when a return receipt is missing or damaged—a transaction associated with the return from among multiple candidate transactions across inventories of one or more sellers. Further, by determining a condition of the item, relative responsibility among seller, customer, and/or an ecommerce provider can be determined, and the return item re-inventoried as appropriate. As such, returns without return receipts—that would otherwise likely have been scrapped or left unaccounted for—are mapped to corresponding sellers and/or re-inventoried for potential resales. This in turn allows for accurate tracking of true inventories of sellers and improves efficiency of returns-processing, for example by fast issuance of compensation to parties in accordance with the determined responsibilities.

Accordingly, data quality of the seller's inventory or the return data associated with the seller's inventory can be improved by preventing processing of incomplete or erroneous return data that include unreported returns. For instance, the data quality of the return data can be improved by at least updating the information regarding completion status of the returns or completed quantity of returns with enhanced accuracy in the seller's inventory or the return data associated with the seller's inventory. Further, for instance, the data quality can be further improved by mapping and/or updating (i) the item condition information indicated by the condition data and/or (ii) the responsibility data regarding compensation into the appropriate transaction within the seller's inventory or the return data. While the description often refers to a single seller, the concepts and advantages described in this disclosure apply to multiple-seller situations as well.

As such, the improvement in data quality can lead to enhanced determination of responsibility, more accurate inventory records (or enhanced data integrity), a streamlined return process, and reduction of misdirected packages, leading to more efficient operations of inventory forecasting and inventory management.

Further, the implementations described herein can also reduce the amount of computer resources that are consumed while processing returns data. For instance, when determining responsibility regarding compensation, a computer system that encounters low quality data (e.g., regarding unreported returns or seller's inventory) can generate results having errors and/or inconsistencies that are not suitable for use. Thus, the computer system can reprocess the data multiple times (e.g., based on manual feedback from a user) until a satisfactory result is achieved. These repeated operations can increase the amount of computation resources (e.g., CPU utilization), memory resources, storage resources, etc.). The implementations described herein can be used to automatically identify and match a transaction associated with a specific unreported return of an item, and determine a relative responsibility among seller, customer, and/or an ecommerce provider regarding compensation associated with the specific unreported return, thereby [1] reducing the likelihood that return data is reprocessed due to low quality and [2] reducing the consumption of computer resources.

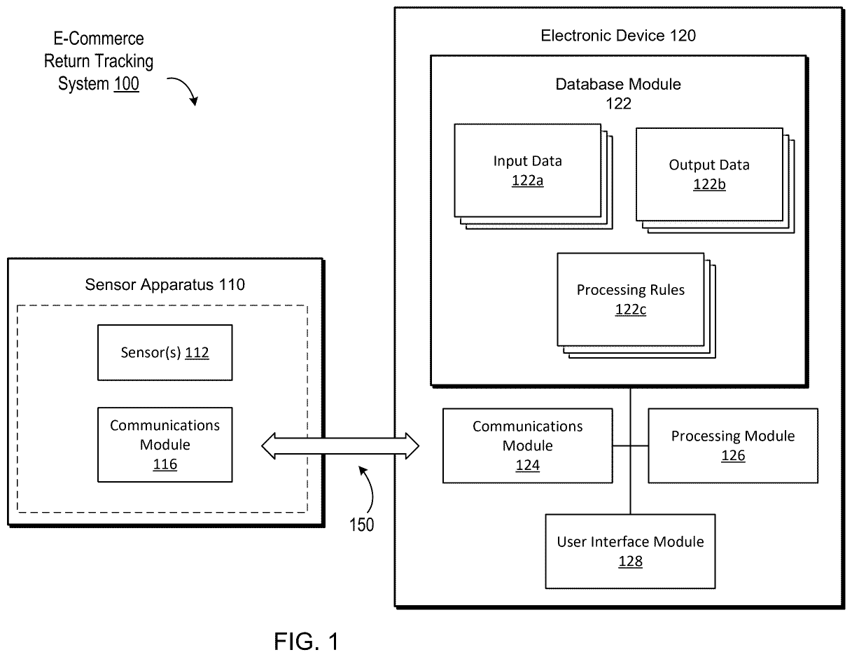

FIG. 1 shows an example of an e-commerce return tracking system 100. In particular, the e-commerce return tracking system 100 can [1] track transactions corresponding to unreported returns in an e-commerce platform, [2] match a transaction associated with a specific unreported return of an item, and [3] determine a relative responsibility among seller, customer, and/or an ecommerce provider regarding compensation associated with the specific unreported return. The e-commerce return tracking system 100 can include an electronic device 120 and a sensor apparatus 110 that are communicatively coupled to one another (e.g., via one or more wired or wireless communications links 150). In general, the e-commerce return tracking system 100 accesses data structures (e.g., customer return data associated with seller's inventory, condition data, or other data stored in a data store 210, such as database module 122 or otherwise accessible to the electronic device 120, for example, through a server) and determine data integrity (e.g., data quality) of the data structures through processing methods according to implementations described in this disclosure. Further, in some implementations, the e-commerce return tracking system 100 obtains sensor data regarding a user using the sensor apparatus 110 and processes the sensor data using the electronic device 120 to determine seller identifier (seller ID) such as seller ID 224 and/or seller item identifier (seller item ID) such as seller item ID 226.

In general, the electronic device 120 can include any number of devices that are configured to receive, process, and transmit data. Examples of the electronic device 120 include client computing devices (e.g., desktop computers or notebook computers), server computing devices (e.g., server computers or cloud computing systems), mobile computing devices (e.g., cellular phones, smartphones, tablets, personal data assistants, notebook computers with networking capability), wearable computing devices (e.g., smart phones or headsets), and other computing devices capable of receiving, processing, and transmitting data. In some implementations, the electronic device 120 can include computing devices that operate using one or more operating systems (e.g., Microsoft Windows, Apple macOS, Linux, Unix, Google Android, and Apple iOS, among others) and one or more architectures (e.g., x86, PowerPC, and ARM, among others).

The sensor apparatus 110 includes one or more sensors 112 configured to capture data on SKUIDs, invoice IDs, labels on packages and/or any other identifiers related to logistics and/or shipping and returns of packages. For instance, the sensor apparatus 110 can include, or correspond to, a wearable device (e.g., smart watch), a smart phone, a packages scanner, or other relevant equipment. As an example, the sensor apparatus can include one or more sensors 112 configured to scan SKUIDs, invoice IDs, or labels on packages. For instance, one or more sensors can be optical sensors, barcode scanners, RFID readers, or any other type of sensor capable of reading SKUIDs, invoice IDs, or package labels.

Further, the sensor apparatus 110 includes a communications module 116 configured to transmit data and/or receive data from the electronic device 120. As an example, the communications module 116 can include one or more receivers, transmitters, and/or transceivers. In some implementations, the communications module 116 can communicate with the electronic device 120 via one or more wireless links (e.g., serial links, Ethernet links, etc.) and/or wireless links (e.g., Wi-Fi links, Bluetooth links, etc.).

In general, the electronic device 120 is configured to receive sensor data (e.g., identifier data such as SKUID) obtained by the sensor apparatus 110, and process the sensor data to determine and/or obtain seller IDs and/or seller item IDs corresponding to one or more items of unreported returns. Further, the electronic device 120 is configured to present information regarding data (e.g., first data structure 240) representing responsibility for return compensation, and any other information to the user and/or another user (e.g., seller).

In FIG. 1, the electronic device 120 is illustrated as a single component. However, in practice, the electronic device 120 can be implemented on one or more computing devices (e.g., each computing device including at least one processor such as a microprocessor or microcontroller). As an example, the electronic device 120 can be a single computing device, such as a single smartphone. As another example, the electronic device 120 can include multiple computing devices that are connected via a network (e.g., the Internet, local area network etc.), and the components of the electronic device 120 can be maintained and operated on some or all of the computing devices. For instance, electronic device 120 can include several computing devices, and the components of the electronic device 120 can be distributed on one or more of these computing devices.

Moreover, the electronic device 120 is illustrated as a component that is separate component from the sensor apparatus 110. However, while the electronic device 120 can be a separate component from the sensor apparatus 110, the electronic device 120 can also include, be coupled with, or be adjacent to the sensor apparatus 110. For example, the electronic device 120 can be a wearable device that includes, is coupled with, or is adjacent to the sensor apparatus 110.

As shown in FIG. 1, the electronic device 120 includes a database module 122, a communications module 124, a processing module 126, and a user interface module 128. The operation modules can be provided as one or more computer executable software modules, hardware modules, or a combination thereof. For example, one or more of the operation modules can be implemented as blocks of software code with instructions that cause one or more processors to execute operations described herein. In addition, or alternatively, one or more of the operations modules can be implemented in electronic circuitry such as, e.g., programmable logic circuits, field programmable logic arrays (FPGA), or application specific integrated circuits (ASIC).

The communications module 124 is configured to transmit data and/or receive data from the sensor apparatus 110. As an example, the communications module 124 can include one or more receivers, transmitters, and/or transceivers. In some implementations, the communications module 124 can communicate with the sensor apparatus 110 (e.g., via the communication module 116) via one or more wired links (e.g., serial links, Ethernet links, etc.) and/or wireless links (e.g., Wi-Fi links, Bluetooth links, etc.).

The database module 122 maintains information related to the operation of the e-commerce return tracking system 100. As an example, the database module 122 can store input data 122a that is used as an input to the e-commerce return tracking system 100. In some implementations, the input data 122a can include at least some of the sensor data generated by the sensor apparatus 110.

As another example, the database module 122 can store output data 122b generated by electronic device 120. In some implementations, the output data 122b can include data corresponding to relative responsibility (including compensation) among a seller, a customer, and/or an e-commerce provider, which can be generated by the electronic device 120 based on the input data 122a.

Further, the database module 122 can store processing rules 122c specifying how data in the database module 122 can be processed to perform the operations described herein. As an example, the processing rules 122c can include one or more rules that specify how the input data 122a is formatted, parsed, and processed to determine (i) a transaction associated with the item being returned among multiple transactions associated with the same type of item and/or (ii) an allocation of relative responsibility among a seller, a customer, and an ecommerce provider regarding compensation associated with the return process. As another example, the processing rules 122c can include one or more rules that specify the conditions in which data is presented to a user (e.g., using the user interface module 128), and the manner in which the data is presented. Further, as another example, the processing rules 122c can include one or more rules that specify the manner in which data is stored for future retrieval and/or processing (e.g., using the database module 122).

Example data processing techniques are described in further detail below.

The processing module 126 processes data stored or otherwise accessible to the electronic device 120. For instance, the processing module 126 can be used to execute one or more of the operations described herein (e.g., by executing the processing rules 122c with respect to the input data 112a in order to generate the output data 122b).

The user interface module 128 is configured to present information to a user and/or to receive inputs from a user. As an example, the user interface module 128 can include one more display devices (e.g., display screens, touch screens, etc.) that are configured to present a user interface (e.g., graphical user interface, GUI) that enables users to interact with the electronic device 120 and/or the sensor apparatus 110. Example interactions include viewing data, transmitting data from one component to another, and/or issuing commands to the electronic device 120 and/or sensor apparatus 110. Commands can include, for example, any user instruction to one or more of the electronic device 120 and/or sensor apparatus 110 to perform particular operations or tasks. In some implementations, the user interface module can also present information to a user aurally (e.g., using one or more speakers) and/or via haptic feedback (e.g., using one more haptic generators, such as a vibration generation).

In some implementations, a software application can be used to facilitate performance of the tasks described herein. As an example, an application can be installed on the electronic device 120. Further, a user can interact with the application to input data and/or commands to the electronic device 120, and review data generated by the electronic device 120.

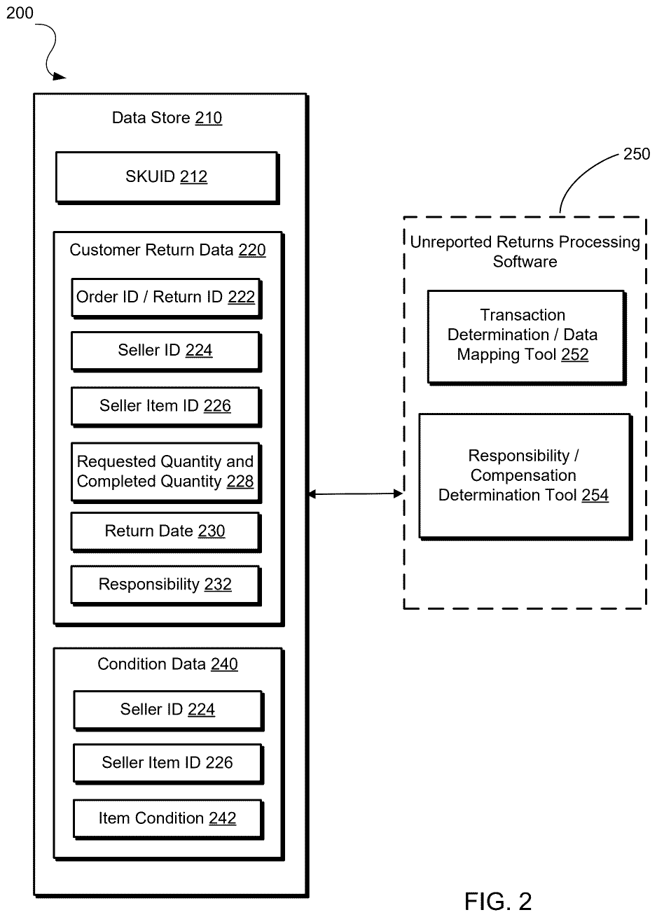

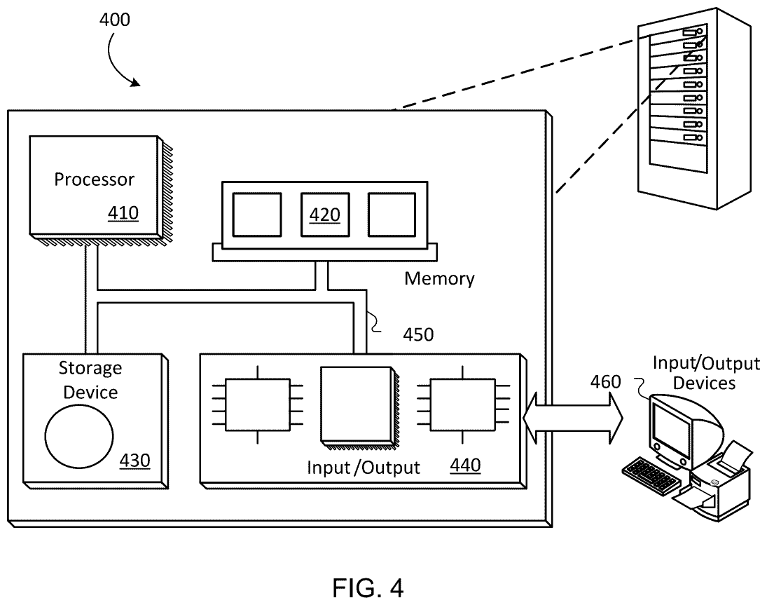

FIG. 2 is an example implementation 200 of a returns processing software or algorithm that is utilized by one or more processor-based electronic devices (e.g., the electronic device 120 of the e-commerce return tracking system 100 of FIG. 1, a computing device (which can also be a server) of a system 400 of FIG. 4)). In particular, the software or algorithm can be utilized by the electronic device to thereby [1] track transactions corresponding to unreported returns in an e-commerce platform, [2] match a transaction associated with a specific unreported return of an item, and [3] determine a relative responsibility among seller, customer, and/or an ecommerce provider regarding compensation associated with the specific unreported return.

The example implementation 200 illustrates a data store 210 and an unreported returns processing software 250.

The data store 210 can include, or correspond to, a data store of the electronic device (which can also correspond to a server) of an e-commerce platform. For instance, the data store 210 can be the database module 122 of the electronic device 120 and one or more storage devices 430 of the computing device (which can also correspond to a server) of the system 400. The data store 210 can be in data communication with the electronic device. Moreover, in some implementations, the data store 201 can be a separate server that is in data communication with the electronic device.

The data store 210 can include SKUID 212, customer return data 220 associated with seller's inventory, and condition data 240. The customer return data 220 can include information regarding order ID and return ID 222, seller ID 224, seller item ID 226, requested quantity and completed quantity 228, return date 230, and responsibility 232. The condition data 240 can include information regarding seller ID 232, seller item ID 234, and item condition 242.

For example, the SKUID 212 can be provided at an original packaging of an item. For example, the SKUID 212 can be linked to a barcode that is located at the original packaging of the item. For example, the barcode can be placed on the item after the item is manufactured and at the time of or as part of the original packaging. For example, the SKUID 212 can be linked, e.g., within the data store 210, to the seller ID 215 and the seller item ID 226 of the customer return data 220 and the condition data 240. In some implementations the seller ID 215 can be equivalent to or correspond to the SKUID 212.

Accordingly, when the barcode on the item is scanned or recognized by a sensor (e.g., the sensor 112), it is possible to identify seller(s) who sells or has sold the item. For example, when the barcode is scanned by the sensor (that is in data communication with the electronic device), the electronic device can recognize the SKUID 212 associated with that specific barcode, and the electronic device can identify corresponding customer return data 220 associated with the seller's inventory.

The customer return data 220 associated with the seller's inventory can include information representing one or more customer's return of items that the one or more customers have purchased. For example, at least some of the customer return data 220 can be generated based on a customer initiating a return. For example, when the customer initiates a return on his or her processor-based device, such as a mobile phone or a personal computer, the electronic device (which can be a server that is in data communication with the data store 210) or other processor-based device (in data communication with the data store 210) can generate and store at least some of the customer return data 220 in the data store 210.

The order ID and return ID 222 can correspond to an identifier associated with an order of the item and an identifier associated with a return of the item, respectively. In cases of unreported returns scenario where return invoice attached to or included in the return package is damaged or missing, the order ID and return ID 222 corresponding to such transaction associated with the corresponding return cannot be tracked based on the invoice (as it is damaged or missing). As such, a transaction corresponding to such order ID and return ID 222 can be tracked using the implementations described in this disclosure, which will be further described below.

The seller ID 214 can correspond to an identifier associated with a specific seller, and the seller item ID 216 can correspond an identifier associated with the specific item that the specific seller sells or has sold. For example, for illustrative purposes, the specific item can be a specific type of a baby diaper, and the seller ID 216 can be associated with that specific type (e.g., specific model, specific product) of baby diaper. For example, for illustrative purposes, the specific seller A sells plurality of that specific type of baby diapers and all of those baby diapers can have the same seller item ID 216.

In some implementations, the seller item ID 216 of the specific item is unique to a specific seller such that no other sellers have the seller item ID 216 for the specific item. Such scenario can be referred herein as a single seller scenario.

In some implementations, the seller item ID 216 of the specific item can be shared among multiple sellers. For example, for illustrative purposes, assuming that the specific item corresponds to the specific type of baby diaper, multiple sellers can use the same seller item ID 216 for that specific type of baby diaper. Such scenario can be referred herein as a multiple-seller scenario.

The requested quantity and completed quantity 228 information represents the quantity of returns that were submitted and the quantity of returns that were completed. For instance, information regarding the quantity of completed returns can be updated after determining relative responsibility among the parties (seller, customer, and/or an ecommerce provider) regarding compensation and/or compensating one or more appropriate parties.

The return date 230 information can correspond to an initiation date of the return process of the item by a customer. In some implementations, the return date 230 can correspond to the date when the return order was created. In some implementations, the return date 230 can correspond to a courier pick-up date of the return package.

Further, the responsibility 232 information can represent the relative responsibility among the parties (seller, customer, and/or an ecommerce provider) regarding the compensation of the item associated with the return. For instance, the responsibility 232 information can be determined based on a set of rules and the condition data 240, as will be further described below.

The condition data 240 includes item condition 242 information indicative of a condition of the item.

In some implementations, the condition data 240 can be determined based on an inspection at the return processing center. For example, based on scanning of the barcode of the item, the SKUID 212 can be retrieved, as well as the seller ID 215 and the seller item ID 226. For example, when an entity (e.g., individual, robot, or the like) scans the SKUID 212 and/or the item condition 242 is determined and/or input, the electronic device or other processor-based device (in data communication with the electronic device) can generate and store at least some of the condition data 240 in the data store 210.

Further, the item condition 242 can be represented in one of the following conditions: scrapped, used, or new. In some implementations, there can be four different categories or levels of the used condition: used-new, used-best, used-normal, and used-good. Each category or level can represent a different level of wear or quality, allowing for a more detailed assessment of the item's condition. For instance, used-new can correspond to a highest level of the used condition and the used-good can correspond to a lowest level of the used condition. In some implementations, there can be less than or more than four categories or levels of the used condition.

In some implementations, the item condition 242 can be determined based on an inspection of the item by the entity. For instance, at the return processing center, the one or more entities can inspect the item in the return package.

Additionally and/or alternatively, the item condition 242 can be determined based on a ML model (e.g., a deep-learning model). For example, the electronic device or other processor-based device (in data communication with the electronic device) can incorporate the ML model. For instance, the training data and output data can be logged in the electronic device or corresponding processor-based device (that is in data communication with the electronic device) to train the ML model. The training data can include pictures of similar types of items in different conditions, for multiple different types of items, and output data can include data representing condition descriptions (or the item condition 242) of the corresponding items. Accordingly, based on one or more pictures of the item as input, the trained ML model can determine the item condition 242. In some implementations, such pictures can be taken automatically or by the entity at the return processing center.

In some implementations, the SKUID 212, the customer return data 220, and the condition data 240 can be stored in a different data store. For instance, one or more of the SKUID 212, the customer return data 220, and the condition data 240 can be stored in a separate server (e.g., a computing device (which can also be a server) of the system 400), while the remaining data can be stored in the data store 210 of the electronic device (which can be a server).

Further, at least some of unreported return tracking, determination of a transaction (e.g., the order ID/return ID 222) associated with a specific unreported return of an item, and determination of a relative responsibility (e.g., the responsibility 232) regarding compensation associated with the specific unreported return can be implemented as respective software programs that may be executed the electronic device. A software program can include machine-readable instructions that may be stored in a memory (such as the database module 122 of FIG. 1, a memory 420, a storage device(s) 430 of FIG. 4), and that, when executed by the processor, cause the processor-based electronic device to perform the instructions of the software program. As shown, the unreported returns processing software 250 can include a transaction determination/data mapping tool 252 and a responsibility/compensation determination tool 254. In some implementations, the unreported returns processing software 250 can include more or fewer tools. In some implementations, some of the tools may be combined, some of the tools may be split into more tools, or a combination thereof. In some implementations, the unreported returns processing software 250 can be run on a server (e.g., a computing device (which can also be a server) of the system 400), or both the electronic device and the server.

In some implementations, the transaction determination/data mapping tool 252 can take a form of a software different from the responsibility/compensation determination tool 254 and run on the server, while the responsibility/compensation determination tool 254 can take a form of the unreported returns processing software 250 and run on the electronic device (e.g., in this scenario, assuming the electronic device does not take a form of a server) that is in data communication with the server. Further variations with respect to the transaction determination/data mapping tool 252 and the responsibility/compensation determination tool 254 being a separate software and being run on the electronic device, the server, or combination thereof, are possible.

The transaction determination/data mapping tool 252 can determine, based on (i) the condition data and (ii) a first set of rules, a transaction (e.g., having respective order ID/return ID 222), among the multiple transactions, associated with the item.

First, the transaction determination/data mapping tool 252 can track transactions corresponding to unreported returns. For example, return transactions of one or more seller's inventory having a return history corresponding to a certain time period can be tracked. For instance, the requested quantity and completed quantity 228 of one or more seller's inventory can be tracked during the certain time period. For instance, the certain time period can be determined based on (i) last determination date for the receipt of return invoice of item(s) from the return date 230 (e.g., date of an initiation of the return processes) and/or (ii) last determination date for the compensation regarding returns.

For example, when completed quantity is not shown or shows zero quantity against the requested quantity of certain item after the last possible date for receiving the return invoice at the return processing center, corresponding transaction having a specific order ID/return ID 222 can be designated as unreported return transaction.

In some implementations, the certain time period can correspond to a period between the last possible date for receiving of the return invoice at the return processing center and last determination date for compensating to one or more appropriate parties. For example, the certain time period can correspond to a period of 35-90 days.

Second, the transaction determination/data mapping tool 252 can determine, based on (i) the condition data 240 and (ii) a first set of rules, the transaction, among the multiple transactions of unreported returns, associated with the item. For example, determining the transaction can include (i) searching, among the multiple transactions, for one or more transactions that satisfy or match the item condition 242 indicated by the condition data 240, and (ii) identifying, among the one or more transactions, the transaction with greatest amount of elapsed time since the initiation of the return process or the return date 230. For example, the customer return data 220 can also include item condition information similar to that of the item condition 242, and the item condition information can be compared to the item condition 242 to help determine that one or more transactions satisfy the item condition 242. For example, the item condition information of the customer return data 220 can be generated based on customer input (e.g., condition, return reason, etc.) entered upon the initiation of the return process.

For example, when the item condition 242 indicates that the item is in scrapped condition, the transaction that satisfies the scrapped condition, a specific order ID/return ID 222 corresponding to a transaction with the greatest amount of elapsed time can be identified.

In some implementations, such greatest amount of elapsed time may have to fall within the certain time period between the last possible date for receiving of the return invoice at the return processing center and last determination date for compensating to one or more appropriate parties. Accordingly, the transaction that satisfies both (i) the item condition 242 and (ii) the greatest amount of elapsed time as described above can be identified as the transaction corresponding to the unreported return of the item. For example, the rationale for the greatest amount of elapsed time occurring before the last determination date for compensating to one or more appropriate parties is to prevent unreported returns from going unprocessed. Otherwise, the unreported returns may not be updated any further.

Additionally, in some implementations, once the transaction is identified, the transaction determination/data mapping tool 252 can update the specifics of the item condition 242 to the customer return data 220 (or the order ID/return ID 222) corresponding to the identified transaction.

In some implementations, in a multiple-seller scenario where the seller item ID 216 of the specific item is shared among multiple sellers (e.g., each seller having different seller ID 224), the transaction determination/data mapping tool 252 can determine one appropriate seller associated with the unreported return item before determining the transaction based on the condition data 240 and the first set of rules. For example, after determining multiple transactions corresponding to unreported returns (having the same seller item ID 216) among multiple sellers as described above, determining the one appropriate seller can include identifying a seller having a transaction (among the transactions) with greatest amount of elapsed time since the return date 230 (or the initiation of a respective return process associated with the seller item ID 216). For example, the greatest amount of elapsed time can be less than a latest threshold date for issuing compensation corresponding to the same type of the item after the initiation of the respective return process. In some implementations, determining the one appropriate seller can include identifying the seller having the transaction (among the transactions) (i) with greatest amount of elapsed time and (ii) at the same time satisfies the item condition 242. For example, as described above, the customer return data 220 associated with each seller's inventory can also include item condition information similar to that of the item condition 242, and the item condition information can be compared to the item condition 242 to help determine that one or more transactions satisfy the item condition 242.

Once the transaction corresponding to the unreported return of the item is determined and/or the item condition 242 is updated on the customer return data 220, the completed quantity portion of the requested quantity and completed quantity 228 information can be updated. For example, the completed quantity can be updated to show the completion status, and it may no longer be empty or no longer show zero against the requested quantity.

Further, once the transaction corresponding to the unreported return of the item is determined and/or the item condition 242 is mapped to the customer return data 220, the responsibility/compensation determination tool 254 can determine, based on the condition data 240, an allocation of relative responsibility among the seller, the customer, and an ecommerce provider regarding compensation associated with the return process. For example, determining, based on the condition data 240, the allocation of relative responsibility can include (i) determining the allocation based on a second set of rules and (ii) assigning the allocation of responsibility to one or more parties among the seller, the customer, and the ecommerce provider. In some implementations, (i) a score can be generated based on a second set of rules, and (ii) the responsibility can be assigned to the one or more parties based on the score. For example, the second set of rules can correspond to rules for determining compensation based on the item condition 242 or generating a score based on the item condition 242.

The second set of rules can include set of instructions for determining the allocation. For example, when the item is in scrapped condition, the e-commerce provider can take the full responsibility and compensate the seller to benefit the seller. For example, when the item is in new condition, the item can be simply re-stocked for sale and thus, responsibility determination may not be necessary or voided. For example, when the item is in used condition, determination of allocation can depend on internal policy or further set of criteria.

In some implementations, when the item is in used condition and at the same time, the item is high compliance item (e.g., items such as baby food that cannot be re-used due to various reasons including legal risk), then the item can be liquidated or re-designated as scrapped, and the e-commerce provider can take the full responsibility and compensate the seller to benefit the seller.

Once the allocation of relative responsibility is determined, a data representing the relative responsibility can be generated. Such data can be stored in the data store 210, transmitted to a computerized analysis platform, and/or output to a user interface for display.

### Example Process

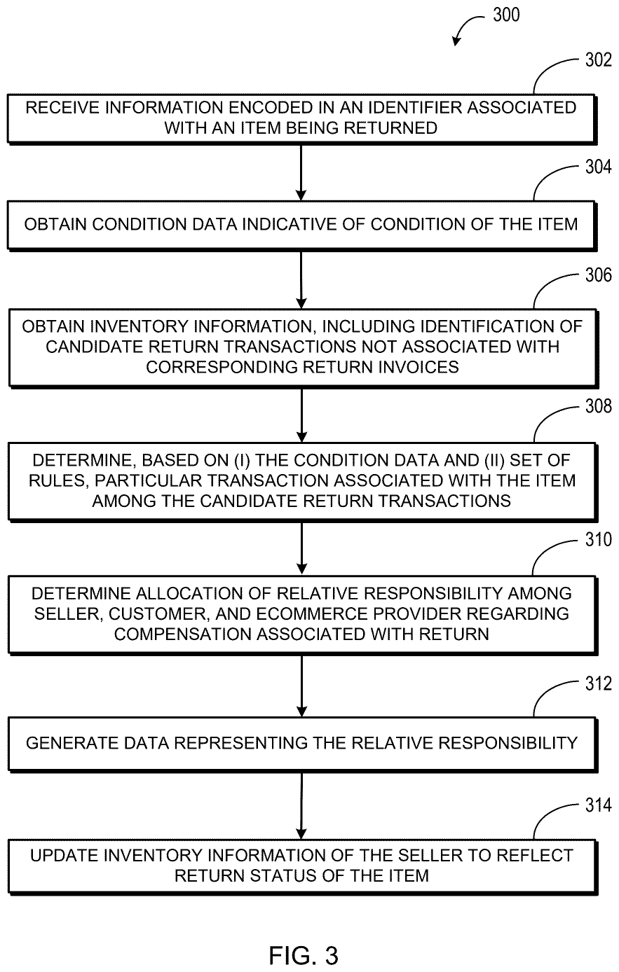

FIG. 3 is a flow chart diagram of an example process 300 for determining a responsibility data for unreported returns in e-commerce transaction. In particular, the example process 300 [1] tracks transactions corresponding to unreported returns in an e-commerce platform, [2] matches a transaction associated with specific unreported return of an item, and [3] determines a relative responsibility among seller, customer, and/or an ecommerce provider regarding compensation associated with the specific unreported return.

The process 300 can be implemented by one or more processor-based systems, such as the e-commerce return tracking system 100, the electronic device described with respect to the example implementation 200, and a system 400, and in conjunction with the example implementation 200, as described in this disclosure.

At 302, information encoded in an identifier associated with an item being returned is received. For instance, the one or more processor-based devices can receive the information encoded in the identifier. For instance, the identifier can correspond to SKUID (e.g., the SKUID 212), where the SKUID can be used to track, or can be associated with, one or more sellers or the inventory information associated with the one or more sellers. For instance, the SKUID can be provided at an original packaging of the item.

At 304, condition data indicative of condition of the item is received. For instance, the one or more processor-based devices can receive the condition data (e.g., the condition data 240). The condition data include information regarding item condition (e.g., the item condition 242). For example, the item condition indicated by the condition data can include a new status, a used status, and a scrap status.

The condition data can also be linked to the identifier such as the SKUID and/or inventory of the one or more sellers. For example, in addition to the item condition (e.g., the item condition 242), the condition data can further include seller identifier (e.g., the seller ID 224) and/or seller's item identifier (e.g., the seller item ID 226), as described above with respect to the example implementation 200. Accordingly, the item condition can be linked to the seller's inventory via or within a data store (e.g., the data store 210).

In some implementations, there can be four different categories or levels of the used condition: used-new, used-best, used-normal, and used-good. Each category or level can represent a different level of wear or quality, allowing for a more detailed assessment of the item's condition. For instance, used-new can correspond to a highest level of the used condition and the used-good can correspond to a lowest level of the used condition. In some implementations, there can be more than or less than four different categories or levels of the used condition.

In some implementations, the seller's item identifier (the seller's item ID) can be equivalent to, or correspond to, the SKUID.

In some implementations, the item condition can be determined based an entity inspecting the item. For instance, at a return processing center of e-commerce platform, the one or more entities can inspect the item in the return package.

In some implementations, the item condition can be determined based on a ML model. For example, the one or more processor-based devices can incorporate the ML model. For instance, the training data and output data can be logged in one or more processor-based devices to train the ML model. The training data can include pictures of similar types of items in different conditions, for multiple different types of items, and output data can include data representing condition descriptions (or the item condition) of the corresponding items. Accordingly, based on one or more pictures of the item as input, the trained ML model can determine the item condition. In some implementations, such pictures can be taken automatically or by the entity at the return processing center.

At 306, inventory information, including identification of multiple candidate return transactions not associated with corresponding return invoices, is obtained. The multiple candidate transactions can (i) be associated with the one or more sellers of items that are substantially similar to, or of the same type as, the item and at the same time, (ii) satisfy a condition that an amount of elapsed time from an initiation of a respective return process meets a first threshold condition. In some implementations, the items that are substantially similar to, or of the same type as, the item can correspond to specific items or products having an identical model number, and/or identical item ID (e.g., the seller item ID 216). For example, for illustrative purposes, the specific item can be a specific type of a baby diaper, and the item ID can be associated with that specific type (e.g., specific model, specific product) of baby diaper. For example, for illustrative purposes, a specific seller A sells plurality of specific type of baby diapers and all of those baby diapers with specific type can have the identical item ID. For example, for illustrative purposes, such baby diapers with specific type and/or model number can be considered substantially similar to, or of the same type as, one another.

The one or more processor-based devices can obtain, the inventory information of the one or more sellers. For instance, the multiple transactions that are not associated with corresponding return invoices items can be determined after the amount of elapsed time from the initiation of each respective return process (e.g., the return date 230) satisfies the first threshold condition. In some implementations, the first threshold condition can be determined based on a latest pre-determined threshold date for receiving a return invoice corresponding to a respective item after the initiation of the respective return process (e.g., the return date) of the respective item. In some implementations, the latest pre-determined threshold date for the first threshold condition can be configurable based on a user input.

In some implementations, the multiple candidate return transactions not associated with corresponding return invoices items can further satisfy a second threshold condition. For instance, an amount of elapsed time from the initiation of the return process may have to be less than a latest pre-determined threshold date for issuing compensation for the corresponding item. In some implementations, the latest pre-determined threshold date for the second threshold condition can be configurable based on a user input.

In some implementations, in a single seller scenario (e.g., the single seller scenario as described above with respect to the discussion of the example implementation 200), only one seller of items is associated with the multiple candidate return transactions. In some implementations, in a multiple-seller scenario (e.g., the multiple seller scenario as described above with respect to the discussion of the example implementation 200), multiple sellers are associated with the multiple candidate return transactions.

In some implementations, the multiple candidate return transactions can be determined based on an entity scanning a barcode that is provided on the packaging of the item and that is associated with the SKUID.

In some implementations, it can be determined whether the multiple candidate transactions are associated with a single seller scenario or a multiple-seller scenario. For example, based on the SKUID and the first threshold condition (and/or the second threshold condition), the one or more processor-based devices can determine whether more than one seller is associated with the multiple candidate return transactions. For example, the SKUID and/or inventory of the one or more sellers can be linked via or within the data store.

At 308, a particular transaction associated with the item among the multiple candidate return transactions is determined based on (i) the condition data and (ii) a first set of rules. For example, the first set of rules can include instructions to (i) search, among the candidate return transactions, for one or more transactions that matches the condition of the item indicated by the condition data, and (ii) identify, among the candidate return transactions, a transaction with greatest amount of elapsed time since an initiation of the respective return process associated with a respective item of the items substantially similar to, or of the same type as, the item. Here, the transaction corresponds to the particular transaction.

In some implementations, each of the multiple candidate return transactions can also include item condition information similar to that of the item condition indicated by the condition data, and the item condition information included in each of the transactions can be compared to the item condition indicated by the condition data to help determine that the one or more transactions satisfies or matches the item condition. For example, the item condition information of each of the multiple candidate return transactions can be generated based on customer input (e.g., condition, return reason, etc.) entered upon the initiation of the return process.

In some implementations, the greatest amount of elapsed time can be less than or equal to a second threshold condition, where the second threshold condition can be determined based on a latest pre-determined threshold date for issuing compensation corresponding to the respective item after the initiation of the respective return process. In some implementations, the latest pre-determined threshold date can be configurable based on a user input.

At 310, an allocation of relative responsibility among the seller, customer, and ecommerce provider regarding compensation associated with return is determined based on the condition data.

For example, determining the allocation of the relative responsibility can include (i) determining the allocation based on a second set of rules and (ii) assigning the allocation of responsibility to one or more parties among the seller, the customer, and the ecommerce provider. In some implementations, (i) a score can be generated based on a second set of rules, and (ii) the responsibility can be assigned to the one or more parties based on the score. For example, the second set of rules can correspond to rules for determining compensation based on the item condition or generating a score based on the item condition.

For example, the second set of rules can include a set of instructions for determining the allocation. For example, when the item is in scrapped condition, the e-commerce provider can take the full responsibility and compensate the seller to benefit the seller. For example, when the item is in new condition, the item can be simply re-stocked for sale and thus, responsibility determination may not be necessary or voided. For example, when the item is in used condition, determination of allocation can depend on internal policy or further set of criteria.

In some implementations, when the item is in used condition and at the same time, the item is high compliance item (e.g., items such as baby food that cannot be re-used due to various reasons including legal risk), then the item can be liquidated or re-designated as scrapped, and the e-commerce provider can take the full responsibility and compensate the seller to benefit the seller.

At 312, data representing the relative responsibility is generated. For example, once the allocation of relative responsibility is determined, the one or more processor-based devices can generate a data representing the relative responsibility The data representing the relative responsibility can include compensation information.

At 314, inventory information of the seller associated with the particular transaction is updated to reflect return status of the item. For instance, the one or more processor-based device can update a requested quantity and a completed quantity (e.g., the request quantity and completed quantity 228) of the seller's inventory information.

In some implementations, the item condition information indicated by the condition data and/or the relative responsibility (or the data representing the relative responsibility) can be incorporated into the seller's inventory. In some implementations, the inventory information of the seller can be updated to reflect availability or non-availability of the item to be re-stocked or included in a future shipment.

In some implementations, the data representing the relative responsibility can be stored in hardware storage device. For example, the data can be stored in the data store. In some implementations, in supplant of, or in addition to, storing the data in the hardware storage device, the data can be output to a user interface (e.g. using the user interface module 128). For example, in cases of outputting the first data structure for user display without storing the data structure, the data can be generated in other format appropriate for display. For example, in cases of outputting the first data structure for user display after storing the data structure, the first data structure can be converted from the storage format to the appropriate display format, and be output.

In some implementations, the data representing the relative responsibility can be generated in a standardized data format appropriate for display or transmittal. For example, a standardized data representing the relative responsibility can be generated for display on the user interface.

In some implementations, the data representing the relative responsibility can be provided or transmitted to a computerized e-commerce analysis platform.

In some implementations, in response to or after generating the data at step 314, the data can be transmitted to a seller's email.

### Example Computer System

FIG. 4 depicts an example computing system, according to implementations of the present disclosure. The system 400 may be used for any of the operations described with respect to the various implementations discussed herein. The system 400 may be included in, used by, in communication with, or correspond to the electronic device 120. Further, the system 400 may include, used by, or in communication with the sensor apparatus 110. The system 400 may include one or more processors 410, a memory 420, one or more storage devices 430, and one or more input/output (I/O) devices 460 controllable through one or more I/O interfaces 440. The various components 410, 420, 430, 440, or 460 may be interconnected through at least one system bus 450, which may enable the transfer of data between the various modules and components of the system 400.

The processor(s) 410 may be configured to process instructions for execution within the system 400. The processor(s) 410 may include single-threaded processor(s), multi-threaded processor(s), or both. The processor(s) 410 may be configured to process instructions stored in the memory 420 or on the storage device(s) 430. The processor(s) 410 may include hardware-based processor(s) each including one or more cores. The processor(s) 410 may include general purpose processor(s), special purpose processor(s), or both.

The memory 420 may store information within the system 400. In some implementations, the memory 420 includes one or more computer-readable media. The memory 420 may include any number of volatile memory units, any number of non-volatile memory units, or both volatile and non-volatile memory units. The memory 420 may include read-only memory, random access memory, or both. In some examples, the memory 420 may be employed as active or physical memory by one or more executing software modules.

The storage device(s) 430 may be configured to provide (e.g., persistent) mass storage for the system 400. In some implementations, the storage device(s) 430 may include one or more computer-readable media. For example, the storage device(s) 430 may include a floppy disk device, a hard disk device, an optical disk device, or a tape device. The storage device(s) 430 may include read-only memory, random access memory, or both. The storage device(s) 430 may include one or more of an internal hard drive, an external hard drive, or a removable drive.

One or both of the memory 420 or the storage device(s) 430 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 400. In some implementations, the CRSM may include a data store that provides storage of computer-readable instructions or other information in a non-transitory format. The CRSM may be incorporated into the system 400 or may be external with respect to the system 400. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 410 and the memory 420 may be supplemented by, or incorporated into, one or more application-specific integrated circuits (ASICs).

The system 400 may include one or more I/O devices 460. The I/O device(s) 460 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 460 may also include one or more output devices such as a display, LED(s), an audio output device (e.g., a speaker), a printer, a haptic output device, and so forth. The I/O device(s) 460 may be physically incorporated in one or more computing devices of the system 400, or may be external with respect to one or more computing devices of the system 400.

The system 400 may include one or more I/O interfaces 440 to enable components or modules of the system 400 to control, interface with, or otherwise communicate with the I/O device(s) 460. The I/O interface(s) 440 may enable information to be transferred in or out of the system 400, or between components of the system 400, through serial communication, parallel communication, or other types of communication. For example, the I/O interface(s) 440 may comply with a version of the RS-232 standard for serial ports, or with a version of the IEEE 1284 standard for parallel ports. As another example, the I/O interface(s) 440 may be configured to provide a connection over Universal Serial Bus (USB) or Ethernet. In some examples, the I/O interface(s) 440 may be configured to provide a serial connection that is compliant with a version of the IEEE 1394 standard.

The I/O interface(s) 440 may also include one or more network interfaces that enable communications between computing devices in the system 400, or between the system 400 and other network-connected computing systems. The network interface(s) may include one or more network interface controllers (NICs) or other types of transceiver devices configured to send and receive communications over one or more networks using any network protocol.

Computing devices of the system 400 may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 400 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

This specification uses the term “configured” in connection with systems and computer program components. For a system of one or more computers to be configured to perform particular operations or actions means that the system has installed on software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

The term “memory subsystem” can include one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially be claimed as such, one or more features from a claimed combination can in some cases be excised from the combination, and the claimed combination may be directed to a sub combination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for processing returns in e-commerce transactions, the method comprising:
receiving, at one or more processing devices, information encoded in an identifier associated with a first item being returned, the identifier being provided on a packaging of the first item;
obtaining, by the one or more processing devices, condition data indicative of condition of the first item;
obtaining, by the one or more processing devices, inventory information including identification of a plurality of candidate return transactions not associated with corresponding return invoices, the plurality of candidate return transactions (i) being associated with one or more sellers of items substantially similar to, or of the same type as, the first item and (ii) satisfying a condition in which an amount of elapsed time from an initiation of a respective return process meets a first threshold condition;
determining, by the one or more processing devices and based on (i) the condition data and (ii) a first set of rules, a particular transaction, among the plurality of candidate return transactions, associated with the first item;
determining, by the one or more processing devices and based on the condition data, an allocation of relative responsibility among a seller associated with the particular transaction, a customer, and an ecommerce provider regarding compensation associated with the return process;
generating, by the one or more processing devices, a data representing the relative responsibility; and
updating, by the one or more processing devices, inventory information of the seller associated with the particular transaction to reflect return status of the first item,
wherein determining, among the candidate return transactions, the particular transaction based on the (i) condition data and (ii) the first set of rules comprises:
searching, among the candidate return transactions, for one or more transactions that matches the condition of the first item indicated by the condition data, and
determining, among the one or more transactions, a transaction with greatest amount of elapsed time since an initiation of the respective return process associated with a respective item of the items substantially similar to, or of the same type as, the first item,
wherein the transaction corresponds to the particular transaction, and
wherein updating the inventory information comprises updating item condition information indicated by the condition data and the data representing the relative responsibility of the particular transaction within the inventory information of the seller.

2. The method of claim 1, wherein the identifier corresponds to a stock keeping unit identifier (SKUID),
wherein the SKUID is associated with the one or more sellers or the inventory information of the one or more sellers, and
wherein the plurality of candidate return transactions are determined based on an entity scanning a barcode that is provided on the packaging of the first item and that is associated with the SKUID.

3. The method of claim 2, comprising:
determining, based on the SKUID and the first threshold condition, whether more than one seller is associated with the plurality of candidate return transactions.

4. The method of claim 1, wherein the first threshold condition is determined based on a latest pre-determined threshold date for receiving a return invoice corresponding to a respective item after the initiation of the respective return process of the respective item, and
wherein the latest pre-determined threshold date is configurable based on a user input.

5. The method of claim 1, wherein the condition of the first item indicated by the condition data comprises a new status, a used status, and a scrap status.

6. The method of claim 5, wherein the greatest amount of elapsed time is less than or equal to a second threshold condition,
wherein the second threshold condition is determined based on a latest pre-determined threshold date for issuing compensation corresponding to the respective item after the initiation of the respective return process, and
wherein the latest pre-determined threshold date is configurable based on a user input.

7. The method of claim 1, wherein the condition data is determined based on a machine learning model using one or more pictures of the first item as input.

8. The method of claim 1, wherein determining, based on the condition data, the allocation of relative responsibility comprises:
generating a score based on a second set of rules, and
assigning, based on the score, the responsibility to one or more parties of the seller, the customer, and the ecommerce provider.

9. The method of claim 1, wherein the first threshold condition is configurable based on a user input.

10. The method of claim 1, comprising:
outputting the data on a display of a user interface.

11. The method of claim 10, wherein outputting the data comprises transmitting a notification including information regarding the responsibility to a user.

12. A system for processing unreported returns in e-commerce transactions, the system comprising:
at least one processor; and
a memory subsystem communicatively coupled to the at least one processor, the memory subsystem storing instructions which, when executed by the at least one processor, cause the at least one processor to perform operations comprising:
receiving information encoded in an identifier associated with a first item being returned, the identifier being provided on a packaging of the first item;
obtaining condition data indicative of condition of the first item;
obtaining inventory information including identification of a plurality of candidate return transactions not associated with corresponding return invoices, the plurality of candidate return transactions (i) being associated with one or more sellers of items substantially similar to, or of the same type as, the first item and (ii) satisfying a condition in which an amount of elapsed time from an initiation of a respective return process meets a first threshold condition;
determining, based on (i) the condition data and (ii) a first set of rules, a particular transaction, among the plurality of candidate return transactions, associated with the first item;
determining, based on the condition data, an allocation of relative responsibility among a seller associated with the particular transaction, a customer, and an ecommerce provider regarding compensation associated with the return process;
generating a data representing the relative responsibility; and
updating inventory information of the seller associated with the particular transaction to reflect return status of the first item,
wherein determining, among the candidate return transactions, the particular transaction based on the (i) condition data and (ii) the first set of rules comprises:
searching, among the candidate return transactions, for one or more transactions that matches the condition of the first item indicated by the condition data, and
determining, among the one or more transactions, a transaction with greatest amount of elapsed time since an initiation of the respective return process associated with a respective item of the items substantially similar to, or of the same type as, the first item,
wherein the transaction corresponds to the particular transaction, and
wherein updating the inventory information comprises updating item condition information indicated by the condition data and the data representing the relative responsibility of the particular transaction within the inventory information of the seller.

13. The system of claim 12, wherein the identifier corresponds to a stock keeping unit identifier (SKUID),
wherein the SKUID is associated with the one or more sellers or the inventory information of the one or more sellers, and
wherein the plurality of candidate return transactions are determined based on an entity scanning a barcode that is provided on the packaging of the first item and that is associated with the SKUID.

14. The system of claim 12, wherein the operations comprise:
determining, based on the SKUID and the first threshold condition, whether more than one seller is associated with the plurality of candidate return transactions.

15. The system of claim 12, wherein the first threshold condition is determined based on a latest pre-determined threshold date for receiving a return invoice corresponding to a respective item after the initiation of the respective return process of the respective item, and
wherein the latest pre-determined threshold date is configurable based on a user input.

16. The system of claim 12, wherein the condition of the first item indicated by the condition data comprises a new status, a used status, and a scrap status.

17. The system of claim 16, wherein the greatest amount of elapsed time is less than or equal to a second threshold condition,
wherein the second threshold condition is determined based on a latest pre-determined threshold date for issuing compensation corresponding to the respective item after the initiation of the respective return process, and
wherein the latest pre-determined threshold date is configurable based on a user input.

18. The system of claim 12, wherein the condition data is determined based on a machine learning model using one or more pictures of the first item as input.

19. The system of claim 12, wherein determining, based on the condition data, the allocation of relative responsibility comprises:
generating a score based on a second set of rules, and
assigning, based on the score, the responsibility to one or more parties of the seller, the customer, and the ecommerce provider.

20. The system of claim 12, wherein the operations comprise:
outputting the data on a display of a user interface.
